(19) United States
(12) Patent Application Publication
(10) Pub. No.: US 2019/0313332 A1
(43) Pub. Date: Oct. 10, 2019

(54) User Equipment (UE) Adaptation Framework for Power Saving

(71) Applicant: MEDIATEK INC., Hsin-Chu (TW)

(72) Inventors: Wei-De Wu, Hsin-Chu (TW); Xiu-Sheng Li, Hsin-Chu (TW); Pei-Kai Liao, Hsin-Chu (TW); Chien-Hwa Hwang, Hsin-Chu (TW)

(21) Appl. No.: 16/373,864

(22) Filed: Apr. 3, 2019

Related U.S. Application Data
(60) Provisional application No. 62/653,755, filed on Apr. 6, 2018.

(51) Int. Cl. H04W 52/02

(52) U.S. Cl. CPC H04W 52/0225

(57) ABSTRACT

Apparatus and methods are provided for narrow band power saving framework. In one novel aspect, the UE configured with multiple BWPs is configured with a plurality of UE states each associated with one or more configured BWP, and transitions to or from a power-saving state upon detecting one or more transitioning conditions. In one embodiment, the UE transitions to and from the power-saving state upon detecting a switching signal. In another novel aspect, the UE with multiple BWPs is further configured with a leader BWP set for a leader cell, and one or more sets of follower BWP sets for corresponding follower cells of the UE, bundles each leader cell UE state with corresponding follower UE state for each follower cell, and transitions from a corresponding follower cell power saving state automatically for the one or more follower cells upon the leader cell UE state transition.

### CROSS REFERENCE TO RELATED APPLICATIONS

This application claims priority under 35 U.S.C. § 119 U.S. provisional application 62/653,755, entitled “NR Power Saving Framework” filed on Apr. 6, 2018, the subject matter of which is incorporated herein by reference.

### TECHNICAL FIELD

The disclosed embodiments relate generally to wireless communication, and, more particularly, to methods and apparatus for UE adaptation framework for power saving.

### BACKGROUND

Mobile networks communication continues to grow rapidly. The mobile data usage will continue skyrocketing. New data applications and services will require higher speed and more efficient. Large data bandwidth application continues to attract more consumers. New technologies are developed to meet the growth such as carrier aggregation (CA), which enables operators, vendors, content providers and the other mobile users to meet the increasing requirement for the data bandwidth. However, carrier aggregation assumes multiple RF chains for signal reception even for physically contiguous spectrum, which introduces long transition time to activate more carriers from one carrier for larger data bandwidth and decreases the efficiency of the data transmission.

In frequency bands above 3 GHz, there could be a block of physically continuous spectrum up to hundreds of MHz. The single carrier operation for such large continuous spectrum is more efficient in both the physical (PHY) control, with lower control signaling overhead, and PHY data, with higher trunking gains. It is, therefore, to configure the large contiguous spectrum for large data transmission instead of configuring multiple small spectrum resources. However, from the system level, not all the user equipment (UEs) require large channel bandwidth. Further, for each UE, not all applications require large channel bandwidth. Given that wideband operation requires higher power consumption, the use of the large spectrum resource for control signaling monitoring and low-data-rate services is not ideal for power saving and bandwidth efficiency. Further, while the UE switches to a smaller channel bandwidth BWP, the behavior of the UE does not change from the large data channel bandwidth BWP. Furthermore, when the UE is configured with multiple cells, such the primary cell and one or more secondary cells, each cell requires separate signaling for transitioning. The overhead of signaling contributes to large amount of UE power consumption on top of the system resource consumption.

A 5G base station/gNB would support enabling reduced UE bandwidth capability within a wideband carrier and enabling reduced UE power energy consumption by bandwidth adaptation. For UEs configured with multiple bandwidth parts (BWPs), the UE can switch BWP to enable faster data transmission or reduce power consumption or for other purposes. The issues remain in implementing the BWP management for UE efficiently.

Improvements and enhancements are required to facilitate 5G base station to support UEs operating with multiple BWPs to facilitate the power-efficient operation for wider bandwidth.

### SUMMARY

Apparatus and methods are provided for narrow band power saving framework. In one novel aspect, the UE configured with multiple BWPs is configured with a plurality of UE states each associated with one or more configured BWP, wherein each UE state is configured with corresponding UE operations and transitions to a power-saving state upon detecting one or more transitioning conditions, wherein the UE switches to a power-saving BWP upon transitioning into the power-saving state. In one embodiment, the UE does not monitor data scheduling on a downlink (DL) and only performs non-grant-based uplink (UL) in the power-saving state. In one embodiment, the transitioning condition is a switching signal indicating transitioning to the power-saving BWP. The switching signal indicates a provision of UE channel state information (CSI) feedback by informing one or more CSI reference resources for a CSI report or triggering UE transmission of Sounding Reference Signal (SRS) to the network. In one embodiment, the switching signal is carried by a downlink control information (DCI) that is not used for data scheduling. In another embodiment, the UE transitioning condition to the power-saving state is a BWP-timer expiration with the power saving BWP configured as a default BWP. The UE transitions from the power-saving state upon detecting a transitioning out condition, wherein the UE switches away from the power-saving BWP. The transitioning out condition is a switching signal indicating transitioning from the power-saving BWP.

In another novel aspect, the UE with multiple BWPs is further configured with a leader BWP set for a leader cell, and one or more sets of follower BWP sets for corresponding follower cells of the UE. The UE configures a plurality of UE states each associated with one or more configured BWP, wherein each UE state is configured with the corresponding UE operations, bundles each leader cell UE state with the corresponding follower UE state for each follower cell, and transitions from a corresponding follower cell power saving state automatically for the one or more follower cells upon the leader cell UE state transition. In one embodiment, the leader cell is a primary cell (PCell) and a follower cell is a secondary cell (SCell). In another embodiment, UE does not monitor control signals in the one or more follower cells when it is in the power-saving state for the follower cells. In one embodiment, the follower cell and each follower cell transition to another BWP state indicated in the switching signal detected by the leader cell.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a system diagram of a wireless network with one more BWPs configured in accordance with embodiments of the current invention.

FIG. 2 illustrates an exemplary diagram for a UE with multiple cells configured with BWPs in accordance with embodiments of the current invention.

FIG. 3 illustrates an exemplary diagram for a UE state with corresponding BWP transitioning in accordance with embodiments of the current invention.

FIG. 4 illustrates exemplary diagrams for a UE power-saving state with the power-saving BWP for the UE in accordance with embodiments of the current invention.

FIG. 5 illustrates exemplary diagrams for the bundled UE state transition for BWP configuration under multi-cell configuration in accordance with embodiments of the current invention.

FIG. 6 illustrates an exemplary flow chart for a UE power-saving state with the power-saving BWP for the UE in accordance with embodiments of the current invention.

FIG. 7 illustrate an exemplary flow chart for the bundled UE state transition for BWP configuration under multi-cell configuration in accordance with embodiments of the current invention.

### DETAILED DESCRIPTION

Reference will now be made in detail to some embodiments of the invention, examples of which are illustrated in the accompanying drawings.

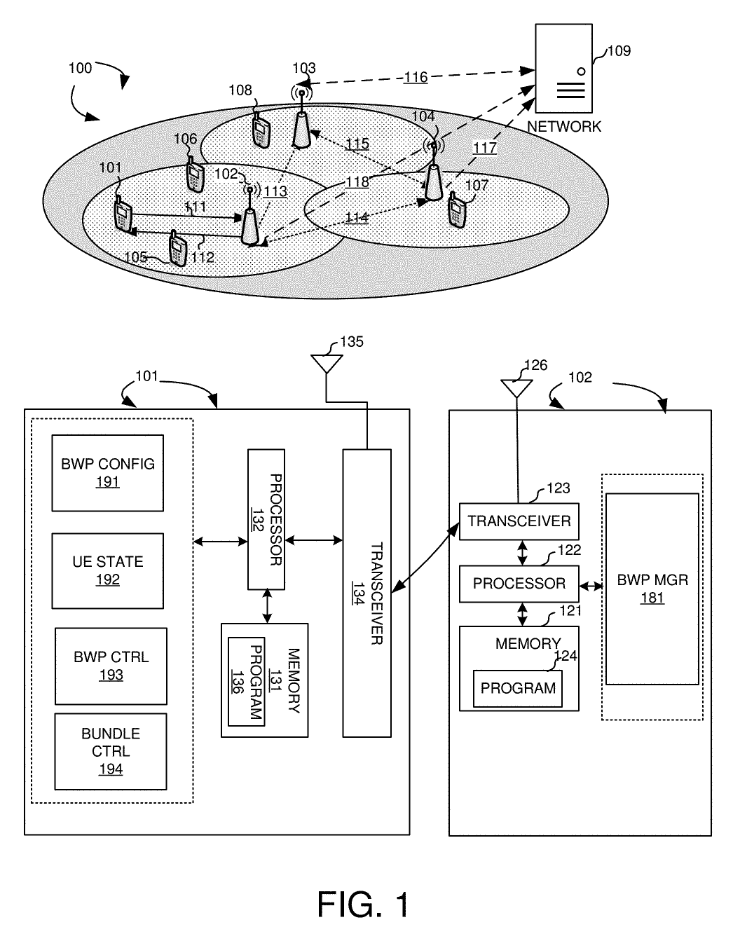

FIG. 1 illustrates a system diagram of a wireless network 100 with one or more BWPs configured in accordance with embodiments of the current invention. Wireless communication system 100 includes one or more wireless communication networks and each of the wireless communication network has fixed base infrastructure units, such as receiving wireless communications devices or base unit 102 103, and 104, forming wireless networks distributed over a geographical region. The base unit may also be referred to as an access point, an access terminal, a base station, a Node-B, an eNode-B, a gNB, or by other terminology used in the art. Each of the base unit 102, 103, and 104 serves a geographic area. Backhaul connections 113, 114 and 115 connect the non-co-located receiving base units, such as 102, 103, and 104. These backhaul connections can be either ideal or non-ideal.

A wireless communications device 101 in wireless network 100 is served by base station 102 via uplink 111 and downlink 112. Other UEs 105, 106, 107, and 108 are served by the same or different base stations. UEs 105 and 106 are served by base station 102. UE 107 is served by base station 104. UE 108 is served by base station 103.

In one novel aspect, wireless communication network 100 operates with large contiguous radio spectrums. UE 101 while accessing wireless communication network 100, acquires synchronization information and system information using primary SS anchor. An SS block consists of synchronization signals and physical broadcast channel carries necessary system information for starting the initial access procedure. UE RF bandwidth adaptation is supported. For more efficient operation of supporting the bandwidth adaptation, one or more bandwidth part (BWP) candidates with configuration parameters are configured per cell (or carrier). The BWP configuration parameters include BWP numerology, such as subcarrier spacing and cyclic prefix (CP) length, the frequency location of the BWP and the BWP bandwidth. In one embodiment, the BWP configuration may further include control and data channel settings such that each BWP setting is associated with UE power consumption characteristics. A BWP may include SS block. UE 101 may be configured with one or more BWPs per cell (or carrier). UE 101 is configured with at least one active DL/UL BWP at any given time. A DL BWP includes at least one control resource (CORESET) for the case of signal active DL/UL BWP at a given time. Each CORESET contains the time-frequency radio resource reserved to accommodate the schedulers for the DL/UL data. UE 101 can be configured with one or more COREETs. A CORESET with a set of candidate locations for the schedulers of system information broadcast, DL broadcast or multicast data is a common search space (CSS) CORESET. A CORESET with a set of candidate locations for the schedulers of DL/UL unicast data is a UE-specific search space CORESET. Radio resource management (RRM) measurement is used for the network to manage the radio resources. RRM measurement includes at least reference signal received power (RSRP) and reference signal received quality (RSRQ).

The UE supports different BWP configurations. In one example, for paired spectrum, up to four UE-specific RRC configured DL BWPs and up to four UE-specific RRC configured UL BWPs per serving cell is supported. For unpaired spectrum, up to four UE-specific RRC configured DL/UL BWP pairs per serving cell is supported.

FIG. 1 further shows simplified block diagrams of wireless device/UE 101 and base station 102 in accordance with the current invention.

Base station 102 has an antenna 126, which transmits and receives radio signals. A RF transceiver module 123, coupled with the antenna, receives RF signals from antenna 126, converts them to baseband signals and sends them to processor 122. RF transceiver 123 also converts received baseband signals from processor 122, converts them to RF signals, and sends out to antenna 126. Processor 122 processes the received baseband signals and invokes different functional modules to perform features in base station 102. Memory 121 stores program instructions and data 124 to control the operations of base station 102. Base station 102 also includes a set of control modules, such as a wide band manager 181 that configures BWP, and communicates with UEs to implement the efficient power-saving framework operations.

UE 101 has an antenna 135, which transmits and receives radio signals. A RF transceiver module 134, coupled with the antenna, receives RF signals from antenna 135, converts them to baseband signals and sends them to processor 132. RF transceiver 134 also converts received baseband signals from processor 132, converts them to RF signals, and sends out to antenna 135. Processor 132 processes the received baseband signals and invokes different functional modules to perform features in mobile station 101. Memory 131 stores program instructions and data 136 to control the operations of mobile station 101.

UE 101 also includes a set of control modules that carry out functional tasks. These functions can be implemented in software, firmware and hardware. A BWP configurator 191 receives a plurality of bandwidth parts (BWPs), wherein a BWP includes a plurality of contiguous physical resource blocks (PRBs). A UE state configurator/circuit 192 configures a plurality of UE states each associated with one or more configured BWP, wherein each UE state is configured with corresponding UE operations. A UE state controller/circuit 193 transitions the UE to a power-saving state or away from the power-saving state upon detecting one or more transitioning conditions, wherein the UE switches to a power-saving BWP upon transitioning into the power-saving state. A bundle controller 194 bundles each leader cell UE state with the corresponding follower UE state for each follower cell and transitions from a corresponding follower cell power saving state automatically for the one or more follower cells upon the leader cell UE state transition.

In one novel aspect, the UE is configured with multiple BWPs. The UE is further configured with multiple UE states each corresponding to one or more multiple BWPs. Each UE state is configured with a set of operations such that the power saving is optimized based on the BWP configurations. Further, the UE can be configured with multiple cells, each with multiple BWPs configured. In another novel aspect, while each configured is configured with corresponding UE states based on the BWP configuration, the UE bundles the UE state transition and operation for a leader cell, such as the primary cell (PCell) with the one or more follower cells, such as the secondary cells (SCells). The following figure illustrates exemplary UE configurations with multiple cells and multiple BWPs.

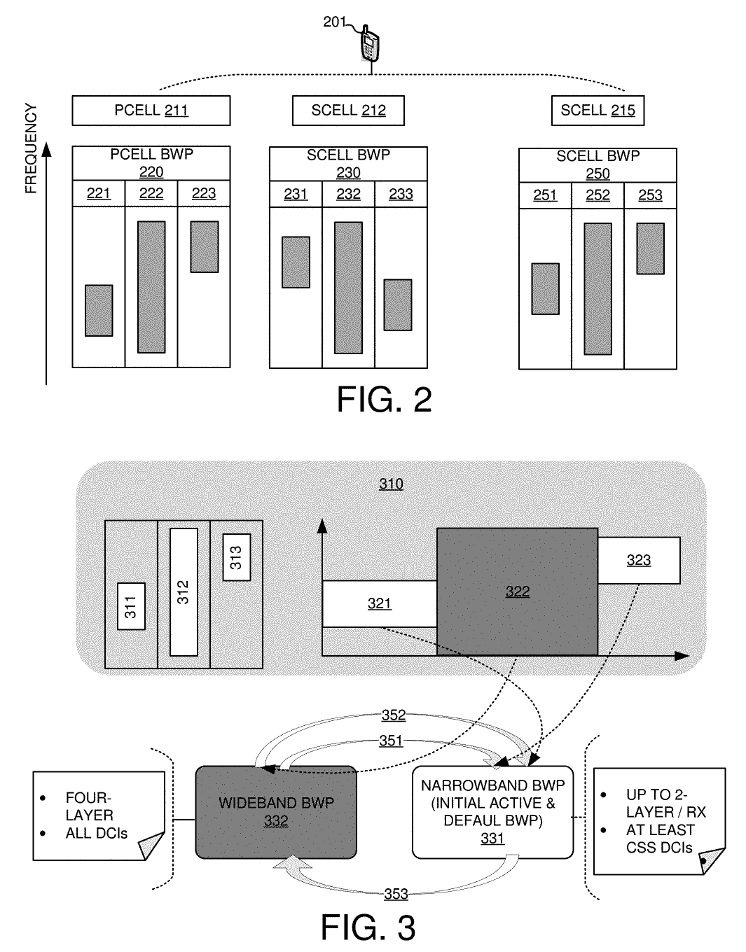

FIG. 2 illustrates an exemplary diagram for a UE with multiple cells configured with BWPs in accordance with embodiments of the current invention. A UE 201 is configured with multiple carriers. As an example, UE 201 has a PCell 211, a SCell 212 and a SCell 215. Each configured carrier is configured with BWPs. PCell BWP 220 is configured with BWP 221, 222, and 223. SCell BWP 230 is configured with BWP 231, 232, and 233. PCell BWP 250 is configured with BWP 251, 252, and 253. Each configured BWP has its numerology, including the CP type and the subcarrier spacing. BWP configuration also includes the frequency location of the BWP, a bandwidth size of the BWP. In one embodiment, multiple UE states are configured for each cell. Each configured UE state is associated with one or more BWPs and corresponds to a set of UE operations. For example, one or more configured BWPs for large data transmission with a large bandwidth BWP is configured to associate with a UE large-data state. One or more configured BWPs for small data transmission with a small bandwidth BWP is configured to associate with a UE small-data state. In one embodiment, the initial active BWP can be associated with the small-data UE state. In another embodiment, the initial active BWP is associated with other UE states, such as an initial-active-BWP UE state. A power-saving state is configured to be associated with a power-saving BWP. The UE is configured with a set of power-saving state operations. In another novel aspect, the PCell and one or more SCells are bundled for the UE state transitioning such that the signal overhead and monitoring consumption are reduced.

In one novel aspect, the BWP configured for the UE not only adapts transmission bandwidth but also determined the UE state with corresponding processing complexity.

FIG. 3 illustrates an exemplary diagram for a UE state with corresponding BWP transitioning in accordance with embodiments of the current invention. In one embodiment, a narrowband operation and a wideband operation is configured for the UE with a wideband UE state corresponding to the one or more configured wideband BWP, and narrowband UE state corresponding to the one or more configured narrowband BWP. FIG. 3 illustrates a BWP configuration 310 for the UE with multiple BWP configured including BWP 311, 312 and 313. BWP 311 and 313 are narrowband BWP. Such BWP may include the initial active BWP of the UE. In one novel aspect, a power-saving BWP is also configured as a narrowband BWP. BWP 312 is a wideband BWP. At time 321, the UE is activated with BWP 311. At time 322, the UE activated with BWP 312. At time 323, the UE is activated with BWP 313. In one novel aspect, the narrowband BWPs 311 and 313 are associated with the configured UE state 331 for narrowband BWPs. Wideband BWP 312 is associated with the configured UE state 332 for wideband BWP. Each UE state is configured with a set of UE operations. For example, while in UE state 311 for narrowband BWP, the UE only monitors up to two signal layers for reception. The UE monitors common search space (CSS) downlink control information (DCI). While in the UE state 312 for wideband BWP, the UE monitors four layers on the reception and all DCIs. In one embodiment, the UE transitions from UE state 331 for narrowband BWP upon detecting/receiving a switching signal. In one embodiment, the switch signal is a signal indicating transitioning to a narrowband BWP, such as BWP 311 or BWP 313. Upon receiving the BWP transition signal, at step 351, the UE also transitions to UE state 331 for narrowband BWP from UE state 332 for wideband BWP. Similarly, at step 353, the UE receives switch signal indicating transitioning to a wideband BWP, such as BWP 312. Upon receiving the BWP transition signal, the UE also transitions from UE state 331 for narrowband BWP to UE state 332 for wideband BWP. In one embodiment, the switch signal is carried in DCI. In another embodiment, the switch signal can be a wake-up signal. In yet another embodiment, the switch signal indicates a provision of UE channel state information (CSI) feedback by informing one or more CSI reference resources for a CSI report or triggering UE transmission of Sounding Reference Signal (SRS) to the network. In one embodiment, at step 352, the UE also transitions to UE state 331 for narrowband BWP upon an expiration of BWP timer.

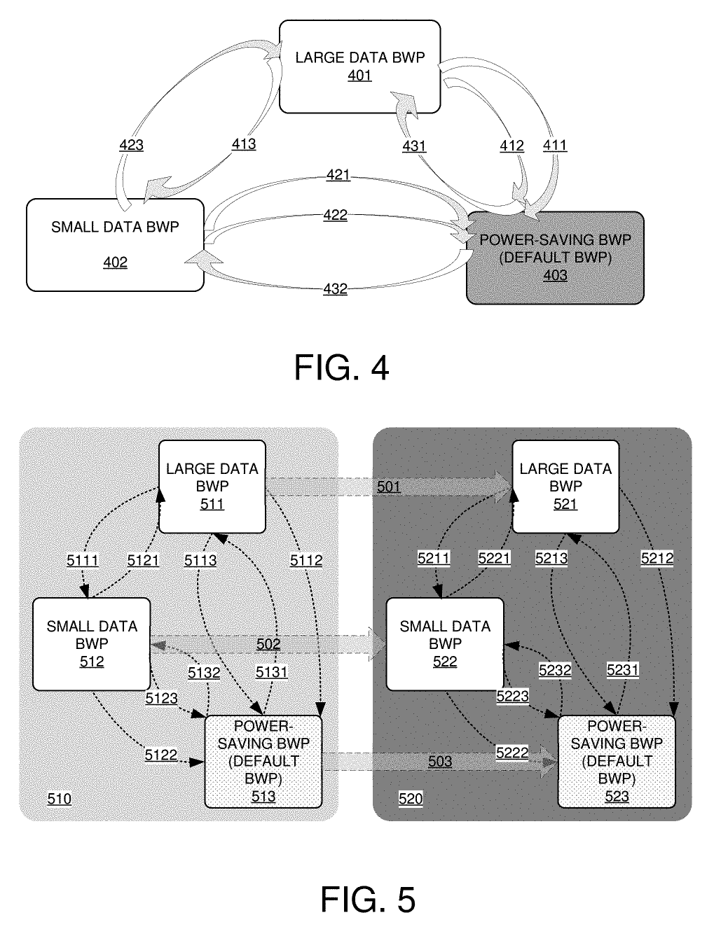

The transitioning of UE state with different UE processing complexity together with the BWP transitioning makes the UE operation more efficient and flexible. In another advantageous point, a new low complexity UE power-saving state is configured by introducing a power-saving BWP as the default BWP. FIG. 4 illustrates the power-saving UE state.

FIG. 4 illustrates exemplary diagrams for a UE power-saving state with the power-saving BWP for the UE in accordance with embodiments of the current invention. In one novel aspect, the power-saving BWP is the default BWP corresponding to the UE power-saving state. As an example, the UE is configured with a UE state 401 for large data BWP, a UE state 402 for small data BWP, and a UE state 403 for the default BWP. It is understood for one with ordinary skills in the art that other UE states can configured corresponding to one or more BWPs. For example, the initial active BWP can be associated with a new UE state of initial-active-BWP state. Alternatively, the initial active BWP can be associated with UE state 402 for the small data BWP. The UE state can be preconfigured and/or dynamically updated. Each UE state is associated with a set of UE operations. For example, UE state 401 for large data BWP. In one embodiment, the UE transitions to the UE power-saving state upon detecting one or more conditions. In one embodiment, the transitioning condition is a switch signaling received/detected by the UE. In one example, the switch signal indicates transitioning the BWP to the default BWP. For example, the UE in the UE state 401 for large data BWP, is configured to monitor four-layer of receiving signals and all DCIs. The UE in the UE state 402 for small data BWP is configured to monitor up to two layers of receiving signals and at least the CSS DCIs. The low complexity UE state 403 for power-saving BWP is configured to monitor only for BWP switching signals. The UE in the UE state 403 does not monitor DL data and only monitors non-grant-based uplink (UL), such as scheduling request (SR) and channel quality index (CQI). The low-complexity power-saving UE state is associated with the power-saving BWP configured as the default BWP. Power-saving efficient operations can be configured for UE power-saving state 403. In one embodiment, there is no DL data in UE state 403 and only limited UL traffic, such as SR and CQI. With no DL data, the UE requires much relaxed preparation. The data processing time and modules can be off in UE state 403. In one embodiment, the UE only monitors for BWP switching signals. In one embodiment the switching signal is 2-bit signal. For example, the 2-bit signal is carried in GC-PDCCH with two bits for BWP switching. It allows sequence-match like simple detection; minimized control decoding complexity. In other embodiments, other wake-up signal design occupying PDCCH CORSET resources can be considered. It can achieve Robust performance with very low code rate and sustain in very poor sync condition with reduced pre-sync frequency or complexity. In another embodiment, the wake-up mechanism can be used as the BWP switching signal.

The power-saving UE state is connected with the default BWP. The UE in the non-power-saving UE states transitions into the UE power-saving state upon detecting one or more predefined conditions. In one embodiment, the transitioning condition is the UE receiving or detecting the switching signal. For example, when UE in the UE state 401 for large data BWP detecting the transitioning signal, the UE transitions to UE state 403 for the default BWP at transition 411. Similarly, transition 421 illustrates the transition to the UE state 403 from UE state 402 for small data BWP upon detecting/receiving switching signal. In one embodiment, the transitioning signal indicates the target BWP the UE is to be transitioned to. For example, transition 411 and 421 the transitioning signal indicates that the UE to be transitioned to the default BWP. The UE upon detecting the switching signal indicating the default BWP, also transition to the UE power-saving state 403 for default BWP. Similarly, the UE in the power-saving state 403 can transition out of the UE power-saving state upon detecting the switching signal. The UE, in UE state 403 for default BWP, transitions to UE state 401 for large data BWP at transition 431 upon detecting the switching signal indicating a large BWP associated with UE state 401 for large data BWP. Similarly, The UE, in UE state 403 for default BWP, transitions to UE state 402 for small data BWP at transition 432 upon detecting the switching signal indicating a small BWP associated with UE state 401 for small data BWP. When there are other UE states configured associated with corresponding one or more BWPs, the UE in UE state 403 for default BWP also transitions to the corresponding UE state based on the destination BWP indicated in the switching signal. The UE in other states also transitions to corresponding UE state associated with the destination BWP in a received/detected switching signal. For example, in transition 413, the UE in UE state 401 for large data BWP transitions to UE state 402 for small data BWP upon detecting switching signal indicating a BWP associated with UE state 402 for small data BWP. In transition 423, the UE in UE state 402 for small data BWP transitions to UE state 401 for large data BWP upon detecting switching signal indicating a BWP associated with UE state 401 for large data BWP. In another embodiment, a BWP timer is used for the UE to transition into the UE power-saving state 403. As illustrated in transition 412, the UE in UE state 401 for large data BWP transitions into UE state 403 for default BWP upon detecting the expiration of the BWP timer. Similarly, in transition 422, the UE in UE state 402 for small data BWP transitions into UE state 403 for default BWP upon detecting the expiration of the BWP timer.

In one novel aspect, the UE configured with multiple cells performs bundled UE state transition such that the signaling overhead and/or monitoring power consumptions are improved to be more efficient.

FIG. 5 illustrates exemplary diagrams for the bundled UE state transition for BWP configuration under multi-cell configuration in accordance with embodiments of the current invention. FIG. 5 illustrates a leader cell 510 with UE leader states associated with BWP configuration for the leader cell and a follower cell 520 with follower states associated with BWP configuration for the follower cell. In one embodiment, the leader cell is the PCell for the UE and a follower cell is a SCell for the UE. In other embodiments, the leader cell can be other type of configured UE cells. One or more similar follower cell/SCell, such as 520 can be configured for the UE. The application uses PCell and SCells to denote the leader cell and the follower cells for illustration.

Leader cell/PCell 510 is configured with UE state 511 for large data BWP, UE state 512 for small data BWP and UE power-saving state 513 for the default BWP. PCell 510 performs BWP and state transition as described in FIG. 4. UE state 511 for large data transitions to UE power-saving 513 in transition 5112 upon detecting the switching signal indicating the default BWP, or upon detecting the BWP timer expiration in transition 5113. UE state 512 for small data transitions to UE power-saving 513 in transition 5122 upon detecting the switching signal indicating the default BWP, or upon detecting the BWP timer expiration in transition 5123. The UE in UE power-saving state 513 transitions away from UE power-saving state 513 upon detecting switching signal indicating a different BWP, such as in transition 5131 the UE transitions to UE state 511 for large data BWP when the switching signal indicating a BWP associated with UE state 511 for large data BWP and in transition 5132 the UE transitions to UE state 512 for small data BWP when the switching signal indicating a BWP associated with UE state 512 for small data BWP. The UE in UE state 511 for large data BWP transitions to UE state 512, in transition 5111, upon detecting switching signal indicating BWP associated with UE state 512 for small data BWP. The UE in UE state 512 for small data BWP transitions to UE state 511, in transition 5121, upon detecting switching signal indicating BWP associated with UE state 511 for large data BWP.

Similarly, SCell/follower cell 520 is configured with UE state 521 for large data BWP, UE state 522 for small data BWP and UE power-saving state 523 for the default BWP. SCell 520 performs BWP and state transition as described in FIG. 4. UE state 521 for large data transitions to UE power-saving 523 in transition 5212 upon detecting the switching signal indicating the default BWP, or upon detecting the BWP timer expiration in transition 5213. UE state 522 for small data transitions to UE power-saving 523 in transition 5222 upon detecting the switching signal indicating the default BWP, or upon detecting the BWP timer expiration in transition 5223. The UE in UE power-saving state 523 transitions away from UE power-saving state 523 upon detecting switching signal indicating a different BWP, such as in transition 5231 the UE transitions to UE state 521 for large data BWP when the switching signal indicating a BWP associated with UE state 521 for large data BWP and in transition 5232 the UE transitions to UE state 522 for small data BWP when the switching signal indicating a BWP associated with UE state 522 for small data BWP. The UE in UE state 521 for large data BWP transitions to UE state 522, in transition 5211, upon detecting switching signal indicating BWP associated with UE state 522 for small data BWP. The UE in UE state 522 for small data BWP transitions to UE state 521, in transition 5221, upon detecting switching signal indicating BWP associated with UE state 521 for large data BWP.

In one novel aspect, leader cell/PCell 510 and one or more follower cells/SCells 520 are bundled with state and BWP transition for power saving. The bundled operation allows the no control monitoring for the follower cells/SCells. In one embodiment, only the leader cell 510 monitors the switch signal in the power-saving state, such as UE state 513. The follower cells/SCells, in the power-saving state, such UE state 523 allows no control signal monitoring. When the leader cell 510 enters UE state 512 for small data BWP, the follower Cell 520 also enters the UE state 522 for small data BWP. In one embodiment, the bundled switching defined via higher layer can save DCI overhead and time for frequently used switches. The associated SCells/follower cells for a bundled switching are configurable. Destination BWP for each CC in a bundle also configurable. With the bundled switch for BWP and UE state, faster access switching of two milliseconds can be realized. As shown, bundle 501 is created to bundle UE state 511 with UE state 521. Similarly, bundle 502 is created to bundle UE state 512 with UE state 522, and bundle 503 is created to bundle UE state 513 with UE state 523. Bundles 501, 502 and 503 configurations may also include corresponding BWP bundles for PCell 510 and SCell 520.

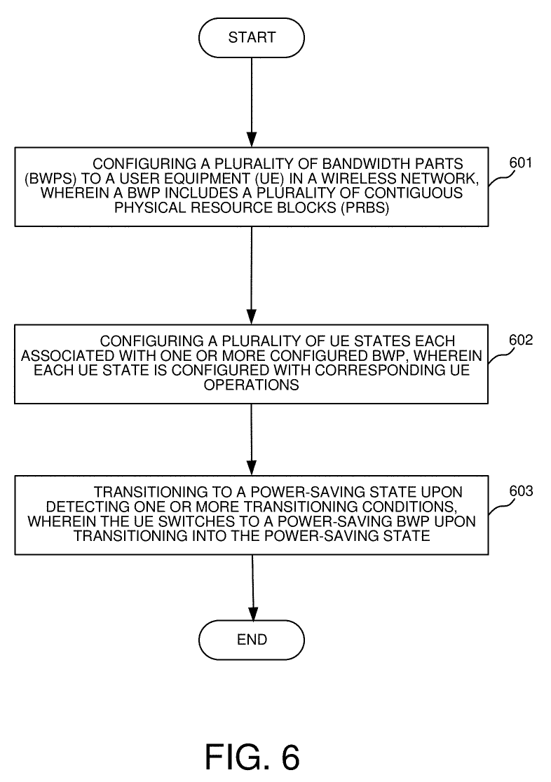

FIG. 6 illustrates an exemplary flow chart for a UE power-saving state with the power-saving BWP for the UE in accordance with embodiments of the current invention. At step 601, the UE configures a plurality of BWPs in a wireless network, wherein a BWP includes a plurality of contiguous PRBs. At step 602, the UE configures a plurality of UE states each associated with one or more configured BWP, wherein each UE state is configured with corresponding UE operations. At step 603, the UE transitions to a power-saving state upon detecting one or more transitioning conditions, wherein the UE switches to a power-saving BWP upon transitioning into the power-saving state.

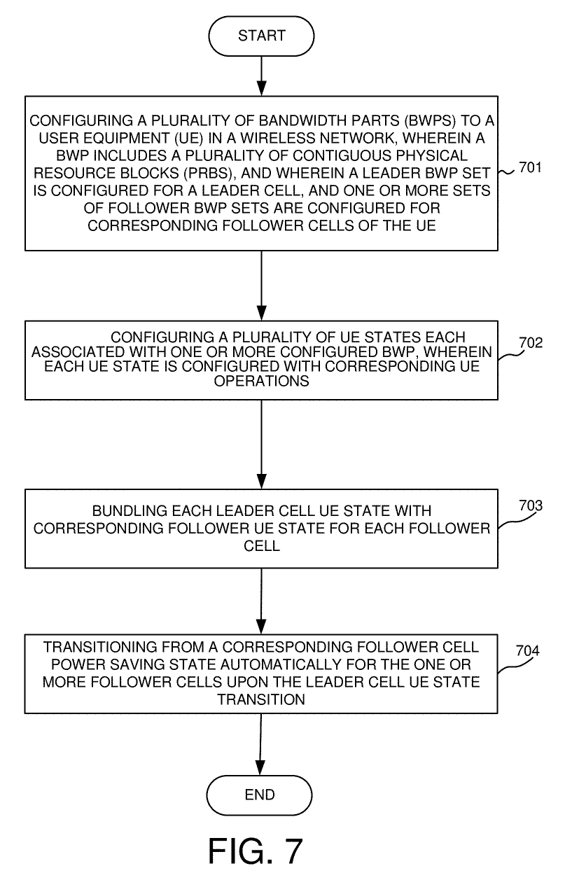

FIG. 7 illustrate an exemplary flow chart for the bundled UE state transition for BWP configuration under multi-cell configuration in accordance with embodiments of the current invention. At step 701, the UE configures a plurality of BWPs in a wireless network, wherein a BWP includes a plurality of contiguous PRBs, and wherein a leader BWP set is configured for a leader cell, and one or more sets of follower BWP sets are configured for corresponding follower cells of the UE. At step 702, the UE configures a plurality of UE states each associated with one or more configured BWP, wherein each UE state is configured with corresponding UE operations. At step 703, the UE bundles each leader cell UE state with corresponding follower UE state for each follower cell. At step 704, the UE transitions from a corresponding follower cell power saving state automatically for the one or more follower cells upon the leader cell UE state transition.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
configuring a plurality of bandwidth parts (BWPs) to a user equipment (UE) in a wireless network, wherein a BWP includes a plurality of contiguous physical resource blocks (PRBs);
configuring a plurality of UE states each associated with one or more configured BWP, wherein each UE state is configured with corresponding UE operations;
transitioning to a power-saving state upon detecting one or more transitioning conditions, wherein the UE switches to a power-saving BWP upon transitioning into the power-saving state.

2. The method of claim 1, wherein the UE does not monitor data scheduling on a downlink (DL) and only performs non-grant-based uplink (UL) in the power-saving state.

3. The method of claim 1, wherein the transitioning condition is a switching signal indicating transitioning to the power-saving BWP.

4. The method of claim 3, further comprising: the switching signal indicates a provision of UE channel state information (CSI) feedback by informing one or more CSI reference resources for a CSI report or triggering UE transmission of Sounding Reference Signal (SRS) to the network.

5. The method of claim 3, wherein the switching signal is carried by a downlink control information (DCI) that is not used for data scheduling.

6. The method of claim 1, wherein the UE transitioning condition to the power-saving state is a BWP-timer expiration with the power saving BWP configured as a default BWP.

7. The method of claim 1, further comprising: transitioning from the power-saving state upon detecting a transitioning out condition, wherein the UE switches away from the power-saving BWP.

8. The method of claim 7, wherein the transitioning condition is a switching signal indicating transitioning from the power-saving BWP.

9. The method of claim 8, wherein the switching signal is carried by a downlink control information (DCI) that is not used for data scheduling.

10. A method, comprising:
configuring a plurality of bandwidth parts (BWPs) to a user equipment (UE) in a wireless network, wherein a BWP includes a plurality of contiguous physical resource blocks (PRBs), and wherein a leader BWP set is configured for a leader cell, and one or more sets of follower BWP sets are configured for corresponding follower cells of the UE;
configuring a plurality of UE states each associated with one or more configured BWP, wherein each UE state is configured with corresponding UE operations;
bundling each leader cell UE state with corresponding follower UE state for each follower cell; and
transitioning from a corresponding follower cell power saving state automatically for the one or more follower cells upon the leader cell UE state transition.

11. The method of claim 10, wherein the leader cell is a primary cell (PCell) and a follower cell is a secondary cell (SCell).

12. The method of claim 10, wherein UE does not monitor control signals in the one or more follower cells when it is in the power-saving state for the follower cells.

13. The method of claim 10, wherein the follower cell and each follower cell transition to another BWP state indicated in the switching signal detected by the leader cell.

14. A user equipment (UE), comprising:
a transceiver that transmits and receives radio frequency (RF) signals from one or more base stations (BS) in wireless network;
a BWP configurator that receives a plurality of bandwidth parts (BWPs), wherein a BWP includes a plurality of contiguous physical resource blocks (PRBs);
a UE state configurator that configures a plurality of UE states each associated with one or more configured BWP, wherein each UE state is configured with corresponding UE operations;
a UE state controller that transitions the UE to a power-saving state or away from the power-saving state upon detecting one or more transitioning conditions, wherein the UE switches to a power-saving BWP upon transitioning into the power-saving state.

15. The UE of claim 14, wherein the transitioning condition is a switching signal indicating transitioning to or from the power-saving BWP, and wherein the UE transitions to the power-saving state if the switching signal indicating transitioning to the power-saving BWP and the UE transitions away from the power-saving state if the switching signal indicating transitioning from the power-saving BWP.

16. The UE of claim 15, further comprising: the switching signal indicates a provision of UE channel state information (CSI) feedback by informing one or more CSI reference resources for a CSI report or triggering UE transmission of Sounding Reference Signal (SRS) to the network.

17. The UE of claim 15, wherein the switching signal is carried by a downlink control information (DCI) that is not used for data scheduling.

18. The UE of claim 14, wherein the UE transitioning condition to the power-saving state is a BWP-timer expiration with the power saving BWP configured as a default BWP.

19. The UE of claim 14, wherein the BWP configurator further receives a leader BWP set for a leader cell, and one or more sets of follower BWP sets for corresponding follower cells of the UE, further comprising: a bundle controller that bundles each leader cell UE state with corresponding follower UE state for each follower cell and transitions from a corresponding follower cell power saving state automatically for the one or more follower cells upon the leader cell UE state transition.

20. The method of claim 10, wherein UE does not monitor control signals in the one or more follower cells when it is in the power-saving state for the follower cells, and wherein the follower cell and each follower cell transition to another BWP state indicated in the switching signal detected by the leader cell.
